(19) United States
(12) Patent Application Publication
(10) Pub. No.: US 2012/0097694 A1
(43) Pub. Date: Apr. 26, 2012

(54) Product Dispensing and Orienting System

(76) Inventor: John A. Gelardi, Midlothian, VA (US)

(21) Appl. No.: 12/908,991

(22) Filed: Oct. 21, 2010

(51) Int. Cl. B65D 83/02; B65G 59/00

(52) U.S. Cl. 221/1; 221/173

(57) ABSTRACT

A product dispensing system including a support structure, a product in rolling engagement with the support structure, the product having a first end and a second end spaced from the first end along a rolling axis, and a catch member positioned to engage the first end of the product and reorient the rolling axis as the product moves along the support structure.

### FIELD

This application relates to product display and dispensing and, more particularly, to apparatus and systems for dispensing, orienting and displaying products initially packaged in containers.

### BACKGROUND

Products are typically shipped to retailers in bulk by enclosing multiple individual product units in a container, such as a carton or box. For example, jarred foods may be shipped to a retailer in a box containing multiple individual jars. Then, a stock clerk typically removes the individual product units from the container and presents them on a display unit, such as a shelf.

Alternatives to the traditional package-ship-unpack-display model are being developed in an effort to improve operating efficiency. For example, U.S. patent application Ser. No. 12/777,444 filed on May 11, 2010, the entire contents of which are incorporated herein by reference, discloses a system for dispensing and displaying products packaged in a container. Specifically, the system includes a frame having a support structure, a product display area and an opening tool. The frame may be positioned on a retailer's shelf and loaded with product simply by placing a container comprising multiple units of product onto the support structure of the frame. As the container is being placed onto the support structure, the opening tool of the frame opens the container in such a manner that product rolls from the container and down to the product display area of the frame under the force of gravity.

The gravity-fed product dispensing systems described above deliver products to the product display area of the dispenser in a rolling configuration, wherein the rolling axis of each product is generally transverse to the longitudinal axis of the dispensing frame and generally parallel with the plane defined by the rolling surface of the dispensing frame. For example, jars dispensed by gravity-fed product dispensing systems are delivered to the product display area of the dispenser in a horizontal configuration.

Most products are typically marked with advertising text and graphics, which are more readily perceived by consumers when the products are in an upright configuration. Therefore, the advertising text and graphics on a product may be less effective when the product is displayed in a rolling (e.g., horizontal) configuration.

Accordingly, those skilled in the art continue with research and development efforts in the field of product display and dispensing.

### SUMMARY

In one aspect, the disclosed product dispensing and orienting system may include a support structure, a product in rolling engagement with the support structure, the product having a first end and a second end spaced from the first end along a rolling axis, and a catch member positioned to engage the first end of the product and reorient the rolling axis as the product moves along the support structure.

In another aspect, the disclosed product dispensing and orienting system may include a support structure, a product in rolling engagement with the support structure, the product having a first end and a second end spaced from the first end along a rolling axis, and a catch member connected to the support structure to engage the first end of the product and reorient the rolling axis as the product moves along the support structure.

In another aspect, the disclosed product dispensing and orienting system may include a support structure, a product in rolling engagement with the support structure, the product having a first end and a second end spaced from the first end along a rolling axis, and a holder connected to the support structure, the holder including a catch member and a recess, wherein the catch member is positioned to engage the first end of the product and urge the product into the recess.

In another aspect, the disclosed product dispensing and orienting system may include a frame having an upper support structure and a lower support structure, a container housing a plurality of products, each product having a first end and a second end, the second end being spaced from the first end along a rolling axis, wherein the container is supported on the upper support structure such that the frame directs the products to the lower support structure, and a catch member positioned to engage the first ends of the products and reorient the rolling axes of the products as the products move along the lower support structure.

In yet another aspect, disclosed is a method for dispensing a product having a first end and a second end, the second end being spaced from the first end along a rolling axis. The method may include the steps of (1) providing a support structure that defines a rolling surface, (2) positioning the product on the rolling surface such that the product rolls about the rolling axis along the rolling surface, and (3) as the product is rolling along the rolling surface, catching one end of the product to cause the rolling axis of the product to rotate, thereby reorienting the product.

Other aspects of the disclosed product dispensing and orienting system and method will become apparent from the following detailed description, the accompanying drawings and the appended claims.

### BRIEF DESCRIPTION OF THE DRAWINGS

FIG. 1 is a front and side perspective view of one aspect of the disclosed product dispensing and orienting system;

FIG. 2 is a side elevational view of the product dispensing and orienting system of FIG. 1;

FIG. 3 is a front elevational view of the product dispensing and orienting system of FIG. 2;

FIG. 4 is a front and side perspective view of the support structure of a product dispensing and orienting system in accordance with a second aspect of the disclosure;

FIG. 5 is a front and side perspective view of the support structure of FIG. 4, shown with a first product partially oriented;

FIG. 6 is a top plan view of the support structure of FIG. 5, shown with the first product fully oriented and a second product partially oriented;

FIG. 7 is a front and side perspective view of the support structure of FIG. 6, shown with the first and second products fully oriented;

FIG. 8 is a front and side perspective view of the support structure of a product dispensing and orienting system in accordance with a third aspect of the disclosure;

FIG. 9 is a front and side perspective view of the support structure of FIG. 8, shown with product in a partially oriented configuration;

FIG. 10 is a front and side perspective view of the support structure of FIG. 9, shown with product in a subsequent partially oriented configuration;

FIG. 11 is a front and side perspective view of the support structure of FIG. 8, shown with product in a fully oriented configuration;

FIG. 12 is a front and side perspective view of the support structure of a product dispensing and orienting system in accordance with a fourth aspect of the disclosure;

FIG. 13 is a front and side perspective view of the support structure of FIG. 12, shown with product in a non-oriented configuration;

FIG. 14 is a front and side perspective view of the support structure of FIG. 13, shown with product in a partially oriented configuration; and

FIG. 15 is a front and side perspective view of the support structure of FIG. 14, shown with product in a fully oriented configuration.

### DETAILED DESCRIPTION

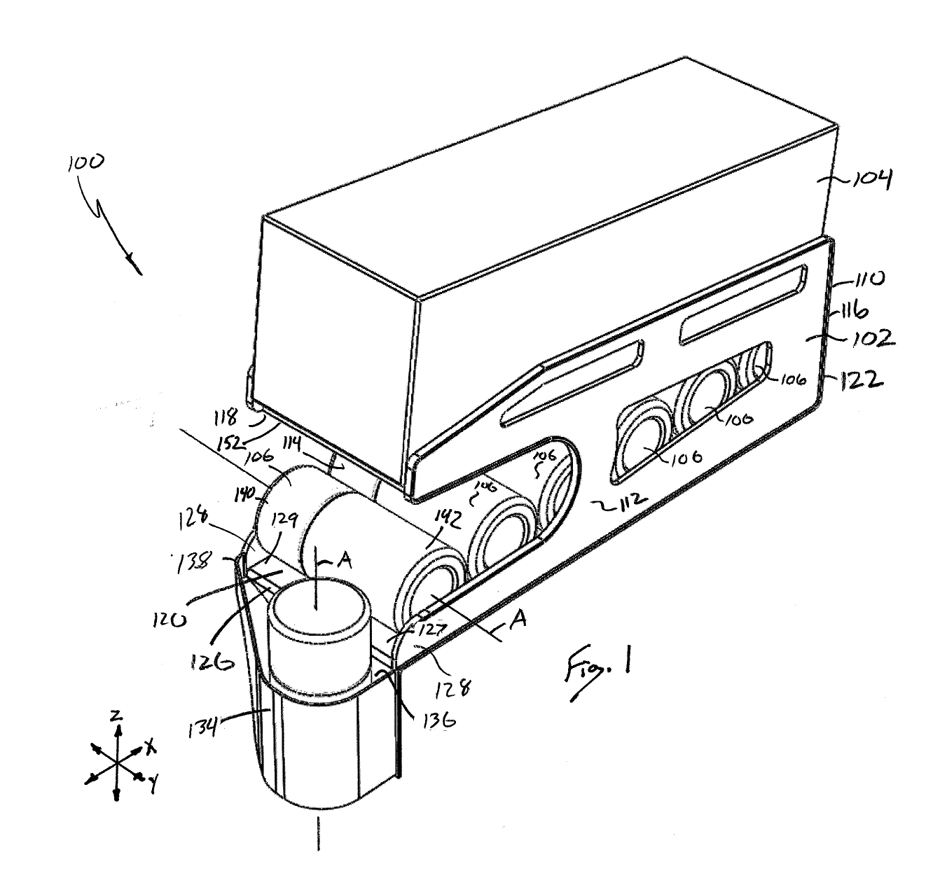

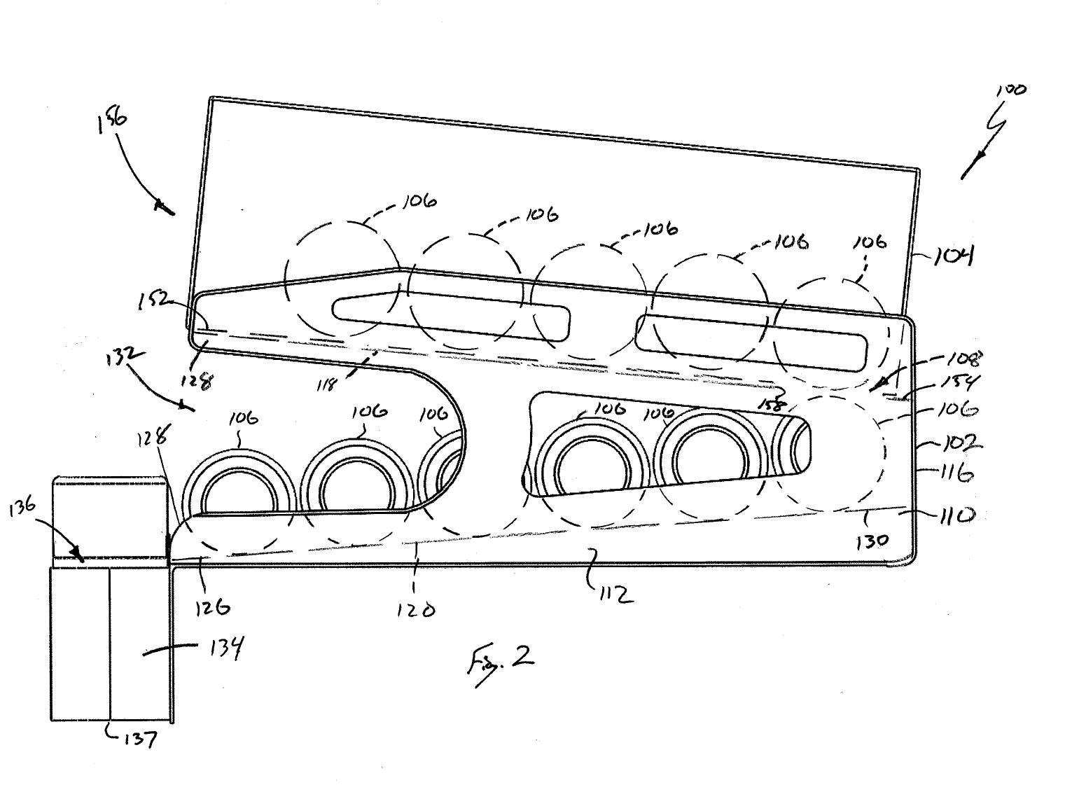

Referring to FIGS. 1-3, one aspect of the disclosed product dispensing and orienting system, generally designated 100, may include a dispenser 102 and a container 104. As shown in FIG. 2, the container 104 may house multiple units of product 106 capable of rolling about a rolling axis A, such as canned or jarred food. The container 104 may be loaded onto the dispenser 102 such that product 106 is released from the container 104 into the dispenser 102 by way of an opening 108 (FIG. 2) in the container 104, thereby allowing the product 106 to be viewed and retrieved by consumers.

The container 104 may be any container capable of housing products 106 and being used with the disclosed dispenser 102. As a non-limiting example, the container 104 may be a six-walled paperboard container that defines an internal volume that may be filled (at least partially) with the products 106. Containers 104 with multiple separate compartments are also contemplated.

The dispenser 102 may include a frame 110 and a holder 134. The frame 110 may support the container 104 and the products 106 dispensed from the container 104, and may direct the dispensed products 106 to the holder 134. The holder 134 may be connected to the frame 110, and may reorient and support the products 106 received from the frame 110. Specifically, the frame 110 may support the products 106 and direct the products 106 to the holder 134 in a horizontal, rolling configuration and the holder 134 may reorient the products 106 to a vertical configuration.

Those skilled in the art will appreciate that the dispenser 102 may include additional components and features without departing from the scope of the present disclosure. For example, the dispenser 102 may also include a cutting element (not shown) connected to the frame 110 and positioned to cut the container 104 and form the opening 108 (FIG. 2) as the container 104 is loaded onto the dispenser 102. The use of cutting elements in connection with product dispensers is described in greater detail in U.S. patent application Ser. No. 12/777,444.

The frame 110 of the dispenser 102 may include a first side wall 112, a second side wall 114, a rear wall 116, an upper support structure 118 and a lower support structure 120. The container 104 may be mounted on the frame 110 and supported on the upper support structure 118 between the side walls 112, 114. The products 106 dispensed from the container 104 may be supported by the lower support structure 120 of the frame 110 between the side walls 112, 114 of the frame 110.

The first side wall 112 may extend longitudinally from a first end 122 of the rear wall 116. The second side wall 114 may be laterally spaced from the first side wall 112, and may extend longitudinally from a second, opposite end 124 of the rear wall 116 such that the second side wall 114 is laterally opposed from the first side wall 112 and generally parallel with the first side wall 112.

The lower support structure 120 may extend laterally between the first and second side walls 112, 114 and longitudinally from the front ends 128 of the side walls 112, 114 to the rear wall 116. Specifically, the lower support structure 120 may include a front end 126 that extends proximate the front ends 128 of the side walls 112, 114, a rear end 130 that is longitudinally opposed from the front end 126 and that extends proximate the rear wall 116, a first (e.g., right) side 127 that is connected to side wall 112, and a second (e.g., left) side that is laterally opposed from the first side 127 and connected to side wall 114. Therefore, the lower support structure 120 and the side walls 112, 114 may define a lower level 132 of the frame 110.

The lower support structure 120 may be formed as a ramp having a rolling surface that is inclined from the front end 126 to the rear end 130 (i.e., the rear end 130 of the lower support structure 120 may be elevated relative to the front end 126). As a non-limiting example, the lower support structure 120 may be inclined at an angle of about 8 degrees. Therefore, products 106 positioned proximate the rear end 130 of the lower support structure 120 may roll about their rolling axes A down to the front end 126 of the lower support structure 120 under the force of gravity.

The upper support structure 118 may extend laterally between the first and second side walls 112, 114, and may include a front end 152 that extends to the front ends 128 of the side walls 112, 114 and a rear end 154 that is longitudinally opposed from the front end 152 and that extends proximate the rear wall 116, thereby defining an upper level 156 of the frame 110. The upper support structure 118 may define an opening 158 proximate the rear wall 116 of the frame 110, which may function as a chute to allow product 106 to move from the upper level 156 to the lower level 132 of the frame 110.

The upper support structure 118 may be declined from the front end 152 to the rear end 154 (i.e., the front end 152 may be elevated relative to the rear end 154). As a non-limiting example, the upper support structure 118 may be declined at an angle of about 8 degrees.

Thus, product 106 supported on the upper support structure 118 (e.g., in a container 104) may roll under the force of gravity down to the rear end 154 of the upper support structure 118, through the opening 158 and, ultimately, to the front end 126 of the lower support structure 120.

The holder 134 may be connected to the front end 126 of the lower support structure 120 and may extend laterally across all or a portion of the front end 126 of the lower support structure 120 of the frame 110. The holder 134 may be any structure configured to engage a product 106 that has rolled into engagement with the holder 134, reorient the rolling axis A of the engaged product 106, and support the product 106 in the reoriented configuration.

In one construction, as shown in FIGS. 1-3, the holder 134 may reorient product 106 from a horizontal rolling configuration to a vertical configuration. Specifically, the rolling axis A of the product 106 may be reoriented from coaxial alignment with the y-axis to coaxial alignment with the z-axis.

In another construction, the holder 134 may be configured such that the rolling axis A of the product 106 may be reoriented from coaxial alignment with the y-axis (i.e., the horizontal, rolling configuration) to coaxial alignment with the x-axis (i.e., the longitudinal axis of the lower support structure 120).

The holder 134 may include a recess 136 that is sized and shaped to closely receive a product 106 therein. A recess 136 capable of receiving multiple products 106 is also contemplated.

In one particular implementation, the recess 136 may be a generally cylindrical recess having a floor 137, and may be sized and shaped to closely receive a product 106 therein when the product 106 is in a vertical configuration (i.e., when the rolling axis A of the product 106 is coaxially aligned with the longitudinal axis of the recess 136).

The recess 136 may be positioned below the front end 126 of the lower support structure 120 such that products 106 transitioning from the front end 126 of the lower support structure 120 to the holder 134 may drop into the recess 136 under the force of gravity.

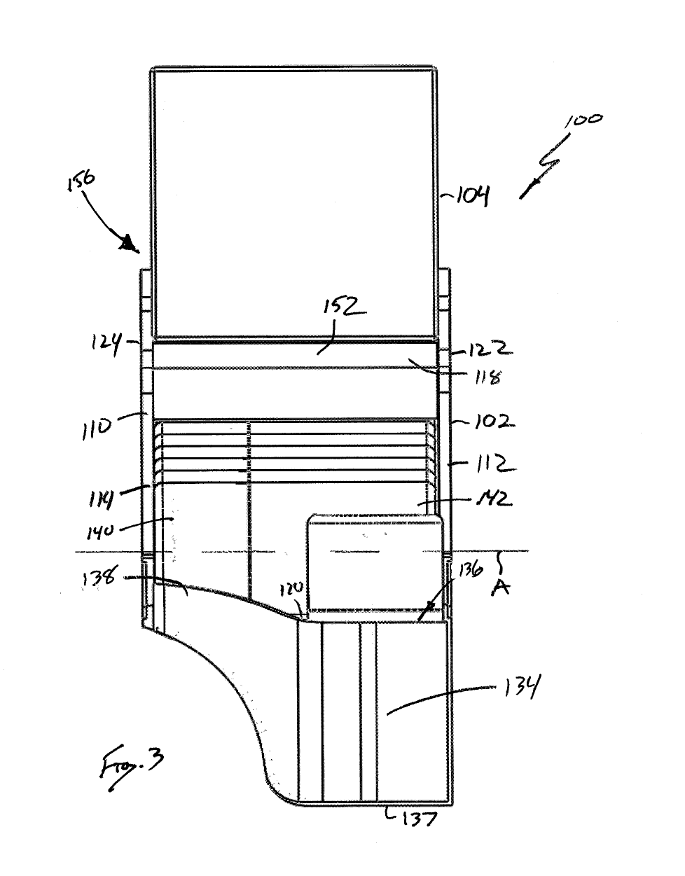

The holder 134 may further include a catch member 138 positioned to engage the products 106 transitioning from the front end 126 of the lower support structure 120 to the holder 134, and direct the products 106 to the recess 136. The catch member 138 may be any structure, such as a wall (or partial wall) (see FIG. 3), a finger, a detent, a protrusion or the like, capable of inhibiting movement of products 106 distally beyond the catch member 138.

The recess 136 defined by the holder 134 may be positioned proximate one of the side walls 112, 114 of the frame 110, while the catch member 138 may be positioned proximate the other side wall 112, 114 of the frame 110. For example, the recess 136 may be positioned proximate side wall 112 and the catch member 138 may be positioned proximate side wall 114.

Each product 106 may include a first end 140 and a second end 142 spaced from the first end 140 along the rolling axis A. Therefore, as a product 106 rolls from the front end 126 of the lower support structure 120 of the frame 110 to the holder 134, the catch member 138 may engage the first end 140 of the product 106, thereby inhibiting further distal movement of the first end 140 of the product 106, while the second end 142 of the product 106 continues to move in the distal direction, resulting in rotation of the product 106 in the x-y plane (FIG. 1). As the second end 142 of the product 142 continues to move in the distal direction, the second end 142 eventually drops into the recess 136, thereby reorienting the product 106 in a vertical configuration (i.e., the rolling axis A is parallel with the z-axis), as shown in FIGS. 1-3.

Accordingly, when a container 104 housing products 106 is loaded onto the dispenser 102, the frame 110 of the dispenser 102 may direct the products 106 in a horizontal, rolling configuration to the front end 126 of the lower support structure 120 of the frame 110 under the force of gravity. From the front end 126 of the lower support structure 120, the products 106 may move to the holder 134 under the force of gravity, where the rolling axis A of each product 106 may be reoriented relative to the longitudinal axis (x-axis) of the lower support structure 120 (e.g., from the horizontal, rolling configuration to a vertical configuration).

In other aspects of the disclosed product dispensing and orienting system, the products may be reoriented within the frame of the dispenser, thereby eliminating the need for a holder connected to the frame. Specifically, the support structure of the frame may be provided with structure for reorienting products relative to the longitudinal axis of the support structure as the products roll along the support structure.

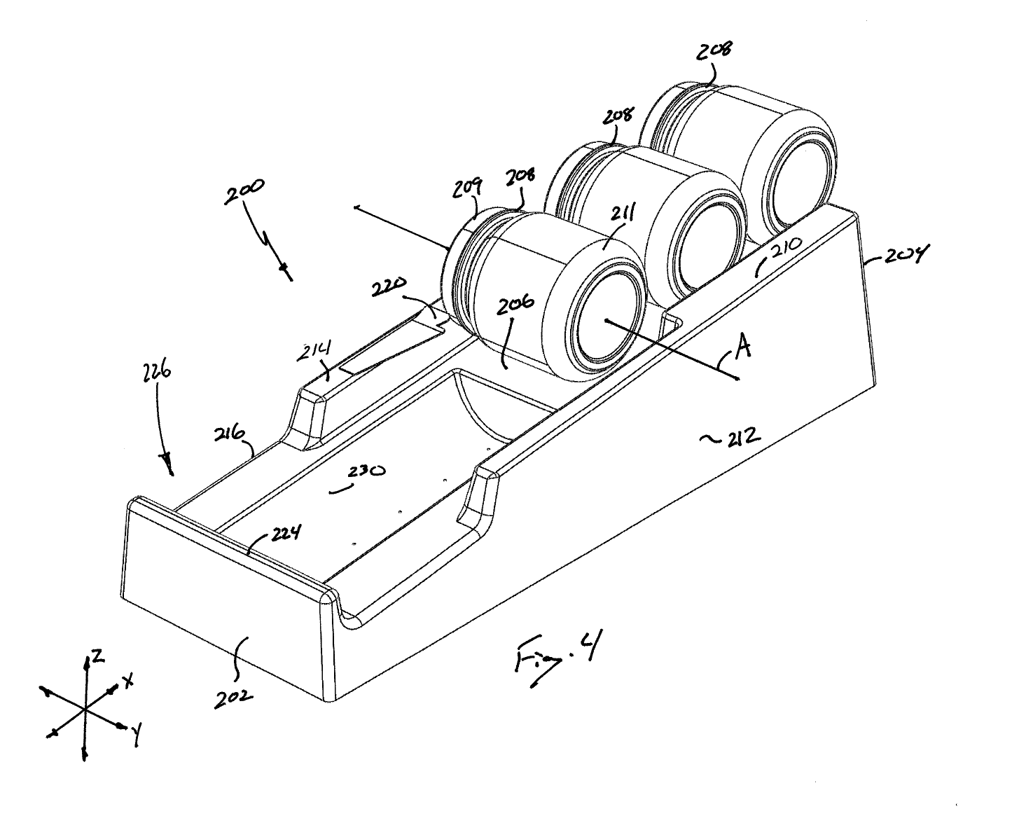

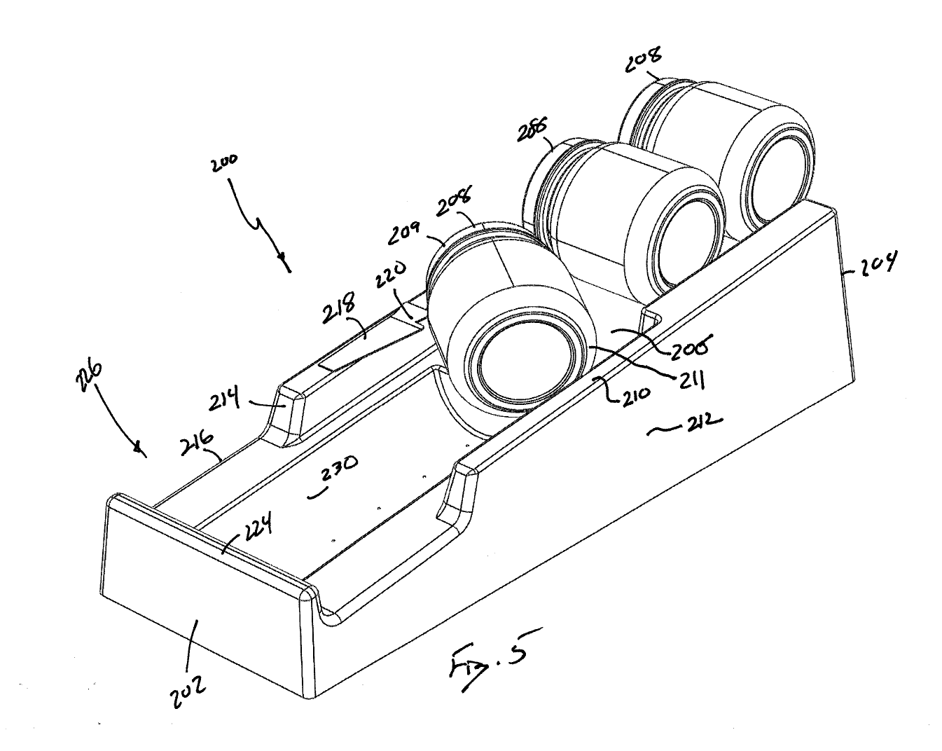

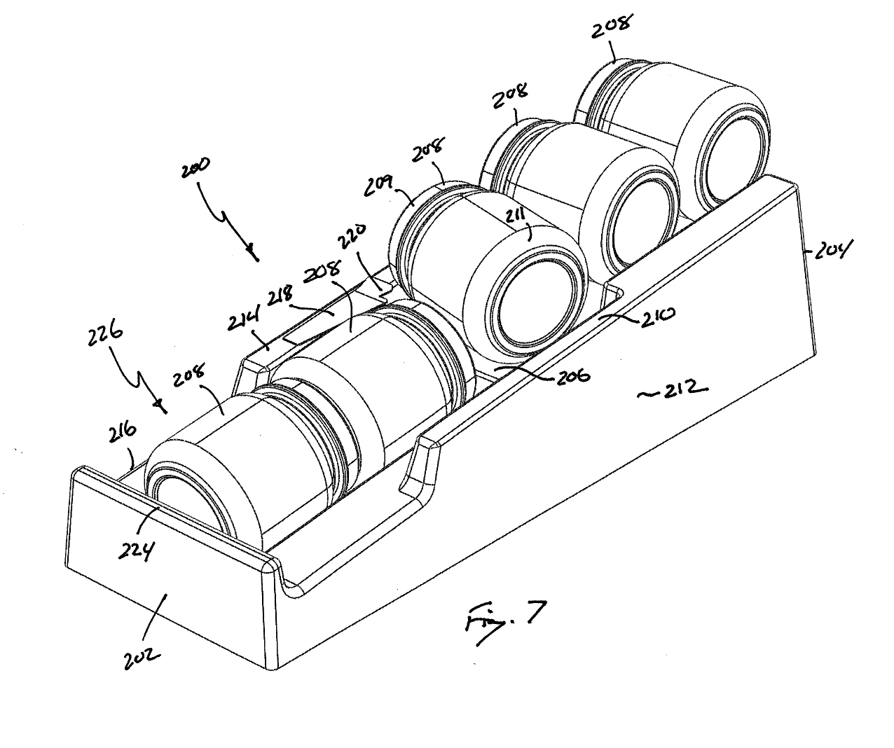

In a second aspect, the disclosed product dispensing and orienting system may include the support structure 200 shown in FIGS. 4-7. In a first implementation of the second aspect, the support structure 200 may be a stand-alone product dispensing and orienting system. In a second implementation of the second aspect, the support structure 200 may be used as the lower support structure of a gravity-fed product dispenser having upper and lower support structures, as described in greater detail above.

The support structure 200 may include a front end 202, a rear end 204 and a rolling surface 206 extending longitudinally from proximate the front end 202 to the rear end 204. The rolling surface 206 may be inclined from proximate the front end 202 to the rear end 204 of the support structure 200 (i.e., the rear end 204 may be elevated relative to the front end 202).

A plurality of products 208, such cans (e.g., canned soup) or jars (e.g., baby food), may be supported on, and in rolling engagement with, the support structure 200. Each product 208 may define a rolling axis A, and may include a first end 209 and a second end 211 opposed from the first end 209 along the rolling axis A.

Thus, under the force of gravity, products 208 positioned in rolling engagement with the support structure 200 proximate the rear end 204 of the support structure 200 may roll about their rolling axes A along the rolling surface 206 and may move down to the front end 202 of the support structure 200.

A first rail or wall 210 may extend along all or a portion of the first (e.g., right) side 212 of the support structure 200 and a second rail or wall 214 may extend along all or a portion of the second (e.g., left) side 216 of the support structure 200. The first and second walls 210, 214 may function as the lateral boundaries of the rolling surface 206, thereby guiding the products 208 along the longitudinal axis (x-axis in FIG. 4) of the support structure 200.

A catch member 218, such as a tab, may be connected to the second wall 214 and may include a protruding portion 220. The protruding portion 220 of the catch member 218 may protrude laterally inward (i.e., toward the first wall 210) to engage the first ends 209 of products 208 moving past the protruding portion 220 in the distal direction (i.e., in the direction of the front end 202 of the support structure 200).

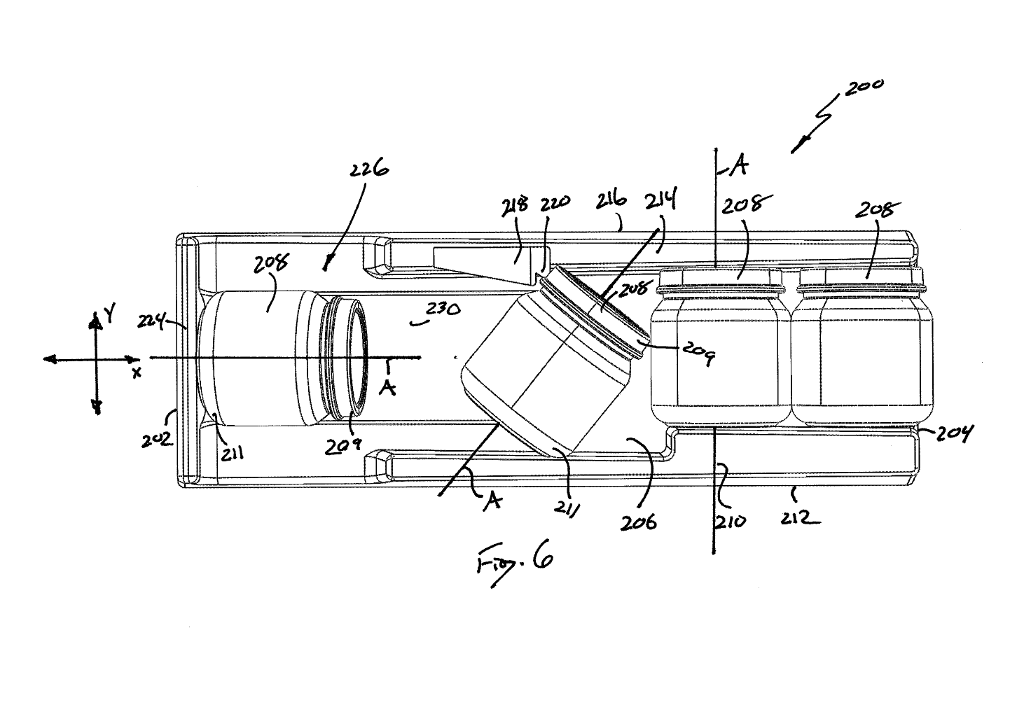

Thus, as a product 208 rolls from the rear end 204 of the support structure 200 toward the front end 202, the protruding portion 220 of the catch member 218 may engage the first end 209 of the product 208, thereby interfering with the distal movement of the first end 209 of the product 208 while the second end 211 of the product 208 continues to move in the distal direction. Therefore, as shown in FIG. 6, the rolling axis A of the product 208 may rotate in the x-y plane from a rolling configuration, wherein the rolling axis A is aligned with the y-axis, to a display configuration, wherein the rolling axis A is aligned with the x-axis (i.e., longitudinal axis of the supported structure 200).

A stop 224 may be positioned proximate the front end 202 of the support structure 200 to prevent products 208 from moving distally beyond the front end 202 of the support structure 200. For example, the stop 224 may be connected to (e.g., integral with) the support structure 200, and may be an upward curve at the front end 202 of the support structure 200. Therefore, the stop 224 may collect product 208 at the front end 202 of the support structure 200, thereby establishing a product display area 226 at the front end 202 of the support structure 200.

Optionally, a cradling recess 230 may be formed in the rolling surface 206 proximate the front end 202 of the support structure 200. The cradling recess 230 may be sized and shaped to cradle one or more products 208 in the display configuration, thereby inhibiting the products 208 from rolling along the y-axis. For example, the cradling recess 230 may be formed as an elongated, hemi-cylindrical channel having a radius that closely corresponds to the radius of the products 208 and a longitudinal length that closely corresponds to the height (or multiples of the height) of each product 208.

Thus, products 208 positioned in a rolling configuration (i.e., with the rolling axis A aligned with the y-axis) proximate the rear end 204 of the support structure 200 may be urged to roll toward the front end 202 of the support structure 200 under the force of gravity. However, as each product 208 passes the catch member 218, the protruding portion 220 of the catch member 218 may engage the first end 209 of the product 208, which may cause the rolling axis A of the product to rotate in the x-y plane and reorient into alignment with the x-axis. As the reoriented product 208 continues to moves distally beyond the catch member 218, the reoriented product 208 may drop into the cradling recess 230 and continue sliding in the distal direction until the product 208 becomes engaged with, and stopped by, the stop 224.

Accordingly, the support structure 200 may direct products from the rear end 204 to the product display area 226 at the front end 202 under the force of gravity. Simultaneously, the support structure 200 may reorient the rolling axis A of each product 208 relative to the longitudinal axis of the support structure 200 (i.e., the x-axis in FIG. 4) as the product 208 moves to the product display area 226.

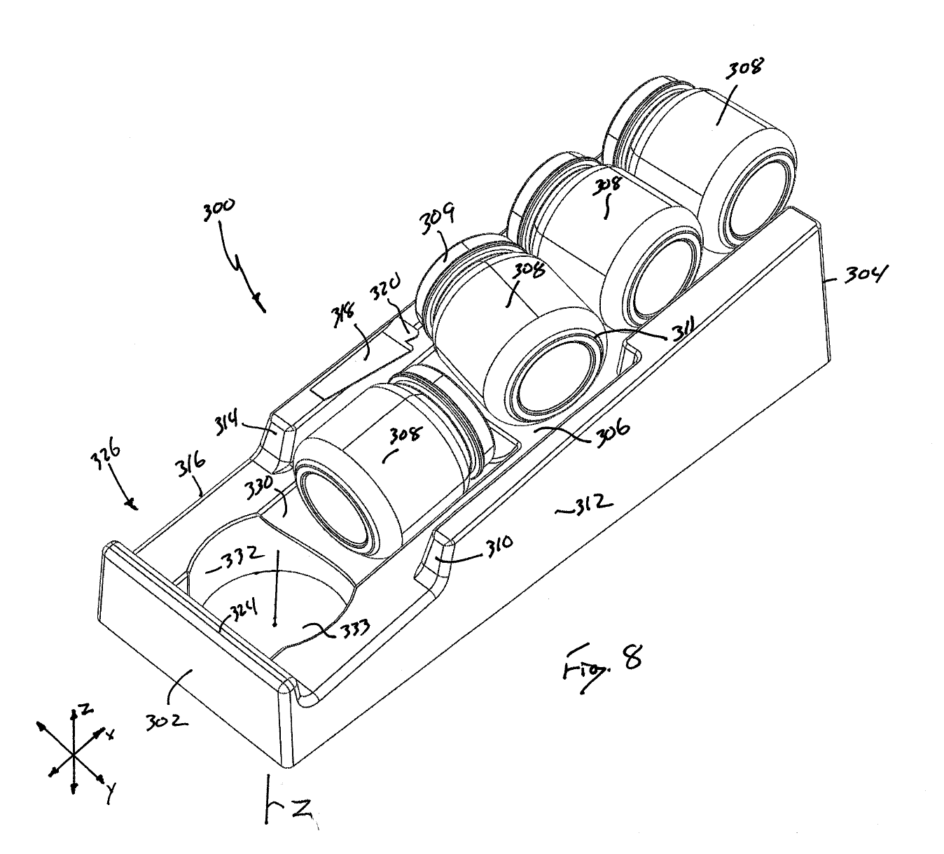

In a third aspect, the disclosed product dispensing and orienting system may include the support structure 300 shown in FIGS. 8-11. In a first implementation of the third aspect, the support structure 300 may be a stand-alone product dispensing and orienting system. In a second implementation of the third aspect, the support structure 300 may be used as the lower support structure of a gravity-fed product dispenser having upper and lower support structures, as described in greater detail above.

The support structure 300 may include a front end 302, a rear end 304 and a rolling surface 306 extending longitudinally from proximate the front end 302 to the rear end 304. The rolling surface 306 may be inclined from proximate the front end 302 to the rear end 304 of the support structure 300 (i.e., the rear end 304 may be elevated relative to the front end 302).

A plurality of products 308 may be supported on, and in rolling engagement with, the support structure 300. Each product 308 may define a rolling axis A, and may include a first end 309 and a second end 311 opposed from the first end 309 along the rolling axis A.

Thus, under the force of gravity, products 308 positioned in rolling engagement with the support structure 300 proximate the rear end 304 of the support structure 300 may roll about their rolling axes A along the rolling surface 306 and may move down to the front end 302 of the support structure 300.

A first rail or wall 310 may extend along all or a portion of the first (e.g., right) side 312 of the support structure 300 and a second rail or wall 314 may extend along all or a portion of the second (e.g., left) side 316 of the support structure 300. The first and second walls 310, 314 may function as the lateral boundaries of the rolling surface 306, thereby guiding the products 308 along the longitudinal axis (x-axis in FIG. 8) of the support structure 300.

A catch member 318, such as a tab, may be connected to the second wall 314 and may include a protruding portion 320. The protruding portion 320 of the catch member 318 may protrude laterally inward (i.e., toward the first wall 310) to engage the first ends 309 of products 308 moving past the protruding portion 320 in the distal direction (i.e., in the direction of the front end 302 of the support structure 300).

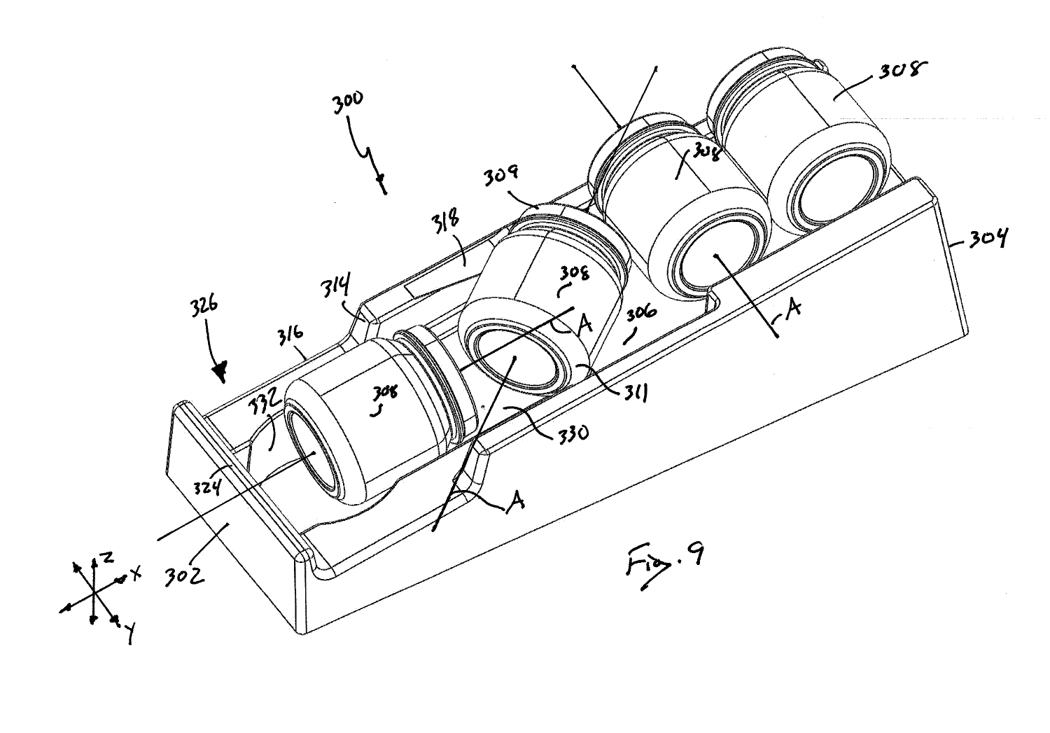

Thus, as a product 308 rolls from the rear end 304 of the support structure 300 toward the front end 302, the protruding portion 320 of the catch member 318 may engage the first end 309 of the product 308, thereby interfering with the distal movement of the first end 309 of the product 308 while the second end 311 of the product 308 continues to move in the distal direction. Therefore, as shown in FIG. 9, the rolling axis A of the product 308 may rotate in the x-y plane from a rolling configuration, wherein the rolling axis A is aligned with the y-axis, to a partially reoriented configuration, wherein the rolling axis A is aligned with the x-axis (i.e., longitudinal axis of the supported structure 300).

A stop 324 may be positioned proximate the front end 302 of the support structure 300 to prevent products 308 from moving distally beyond the front end 302 of the support structure 300. Therefore, the stop 324 may collect product 308 at the front end 302 of the support structure 300, thereby establishing a product display area 326 at the front end 302 of the support structure 300.

A cradling recess 330 may be formed in the rolling surface 306 distal of the catch member 318. The cradling recess 330 may be sized and shaped to cradle one or more products, thereby inhibiting the products 308 from rolling along the y-axis. For example, the recess 330 may be formed as an elongated, hemi-cylindrical channel.

A vertical recess 332 may be formed in the rolling surface 306 proximate the front end 302 of the support structure 300. In one expression, the vertical recess 332 may be a generally cylindrical recess having a floor 333, and may be sized and shaped to closely receive and support a product 308 therein in a vertical configuration (i.e., with the rolling axis A of the product 308 coaxially aligned with the vertical axis Z of the vertical recess 332).

The vertical recess 332 may be distal of the cradling recess 330, and may be positioned below the cradling recess 330 such that products 308 moving in the distal direction from the cradling recess 330 may drop into the vertical recess 332 under the force of gravity.

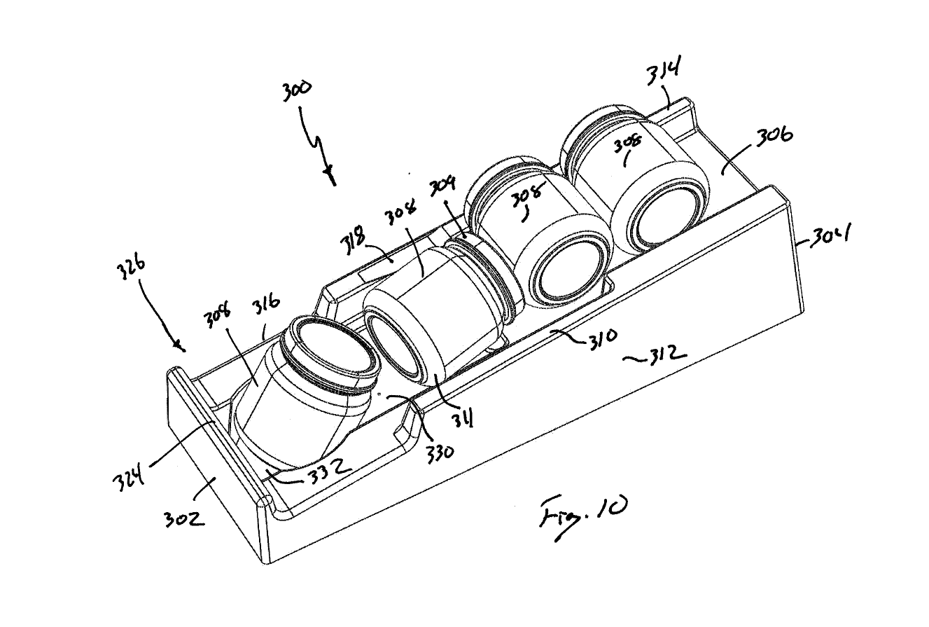

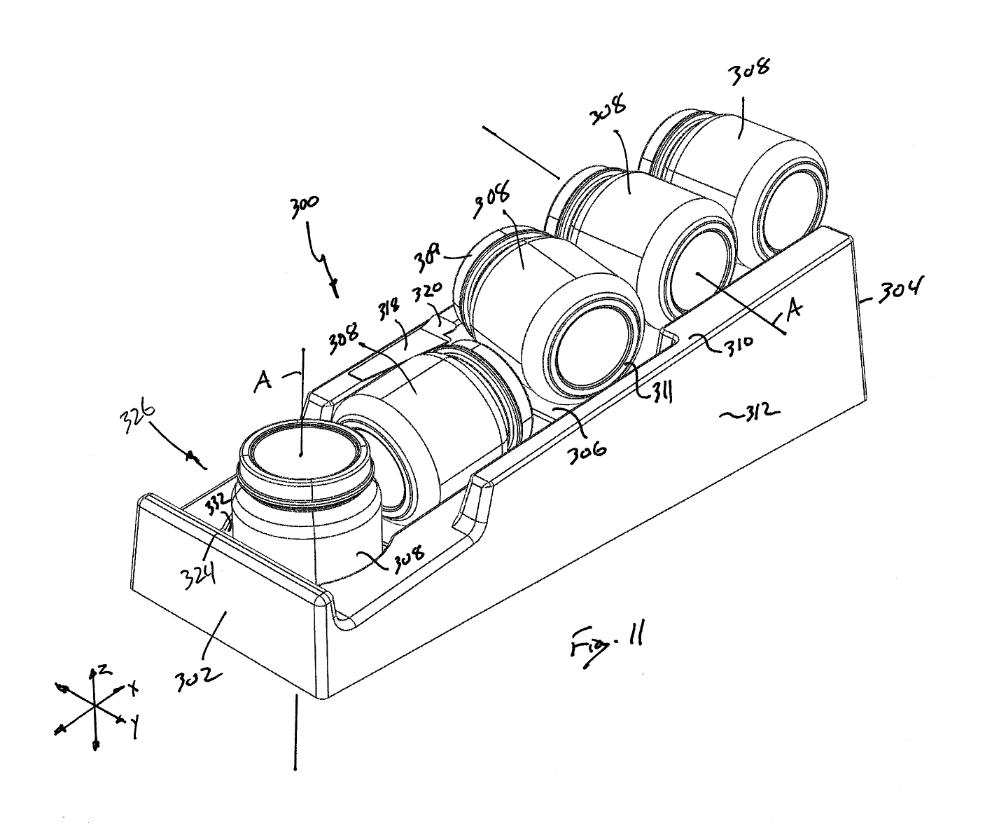

Thus, products 308 positioned in a rolling configuration (i.e., with the rolling axis A aligned with the y-axis) proximate the rear end 304 of the support structure 300 may be urged to roll toward the front end 302 of the support structure 300 under the force of gravity. However, as each product 308 passes the catch member 318, the protruding portion 320 of the catch member 318 may engage the first end 309 of the product 308, which may cause the rolling axis A of the product to rotate in the x-y plane and reorient into alignment with the x-axis, as shown in FIG. 9. With the product 308 aligned with the x-axis and moving in the distal direction, the product 308 may drop into the cradling recess 330, as shown in FIG. 8. Then, as the product 308 continues to move in the distal direction, the second end 311 of the product 308 may drop into the vertical recess 332, thereby reorienting the product 308 in a vertical configuration such that the rolling axis A is coaxially aligned with the vertical axis Z of the vertical recess 332, as shown in FIGS. 10 and 11.

Accordingly, the support structure 300 may direct products from the rear end 304 to the product display area 326 at the front end 302 under the force of gravity. Simultaneously, the support structure 300 may reorient the rolling axis A of each product 308 into a vertical configuration (i.e., aligned with the vertical axis Z) as the product 308 moves to the product display area 326.

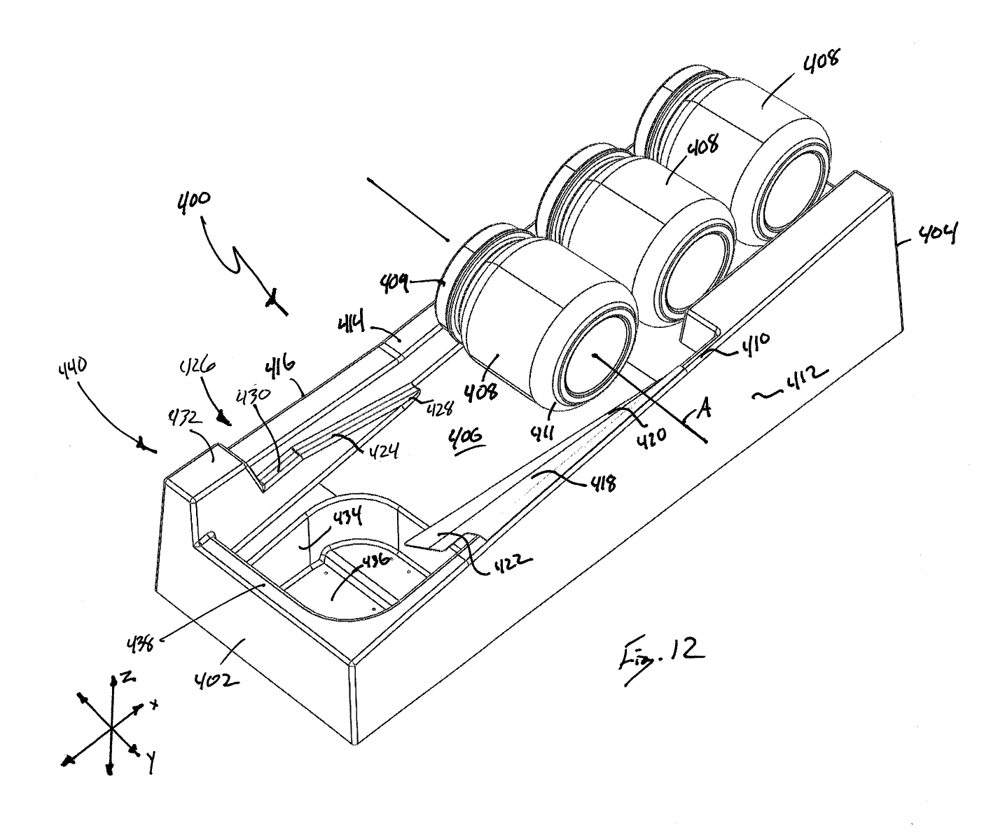

In a fourth aspect, the disclosed product dispensing and orienting system may include the support structure 400 shown in FIGS. 12-15. In a first implementation of the fourth aspect, the support structure 400 may be a stand-alone product dispensing and orienting system. In a second implementation of the fourth aspect, the support structure 400 may be used as the lower support structure of a gravity-fed product dispenser having upper and lower support structures, as described in greater detail above.

The support structure 400 may include a front end 402, a rear end 404 and a rolling surface 406 extending longitudinally from proximate the front end 402 to the rear end 404. The rolling surface 406 may be inclined from proximate the front end 402 to the rear end 404 of the support structure 400 (i.e., the rear end 404 may be elevated relative to the front end 402).

A plurality of products 408 may be supported on, and in rolling engagement with, the support structure 400. Each product 408 may define a rolling axis A, and may include a first end 409 and a second end 411 opposed from the first end 409 along the rolling axis A.

Thus, under the force of gravity, products 408 positioned in rolling engagement with the support structure 400 proximate the rear end 404 of the support structure 400 may roll about their rolling axes A along the rolling surface 406 and may move down to the front end 402 of the support structure 400.

A first rail or wall 410 may extend along all or a portion of the first (e.g., right) side 412 of the support structure 400 and a second rail or wall 414 may extend along all or a portion of the second (e.g., left) side 416 of the support structure 400. The first and second walls 410, 414 may function as the lateral boundaries of the rolling surface 406, thereby guiding the products 408 along the longitudinal axis (x-axis in FIG. 12) of the support structure 400.

A first ramp 418 may extend along the first wall 410 and may include a rear end 420 and a front end 422. The front end 422 of the first ramp 418 may be spaced from the front end 402 of the support structure 400 and may be level with, or elevated relative to, the rear end 420 of the first ramp 418. The rear end 420 of the first ramp 418 may transition to the rolling surface 406 of the support structure 400.

A second ramp 424 may extend along the front end 426 of the second wall 414 and may include a rear end 428 and a front end 430. The front end 430 of the second ramp 424 may be level with, or elevated relative to, the rear end 428 of the second ramp 424. The rear end 428 of the second ramp 424 may transition to the rolling surface 406 of the support structure 400.

A catch member 432 may be positioned at the front end 430 of the second ramp 424. The catch member 432 may be any structure, such as a post, wall, a finger, a detent, a protrusion or the like, capable of inhibiting movement of products 408 distally beyond the catch member 432.

A recess 434 may be formed in the rolling surface 406 proximate the front end 402 of the support structure 400. In one expression, the recess 434 may be a generally cylindrical recess having a floor 436, and may be sized and shaped to closely receive and support a product 408 therein in a vertical configuration (i.e., with the rolling axis A of the product 308 coaxially aligned with the vertical axis (i.e., the z-axis) of the recess 434).

A stop 438 may be positioned proximate the front end 402 of the support structure 400 to prevent products 408 from moving distally beyond the front end 402 of the support structure 400. Therefore, the recess 434 and the stop 438 may collect products 408 at the front end 402 of the support structure 400, thereby establishing a product display area 440 at the front end 402 of the support structure 400.

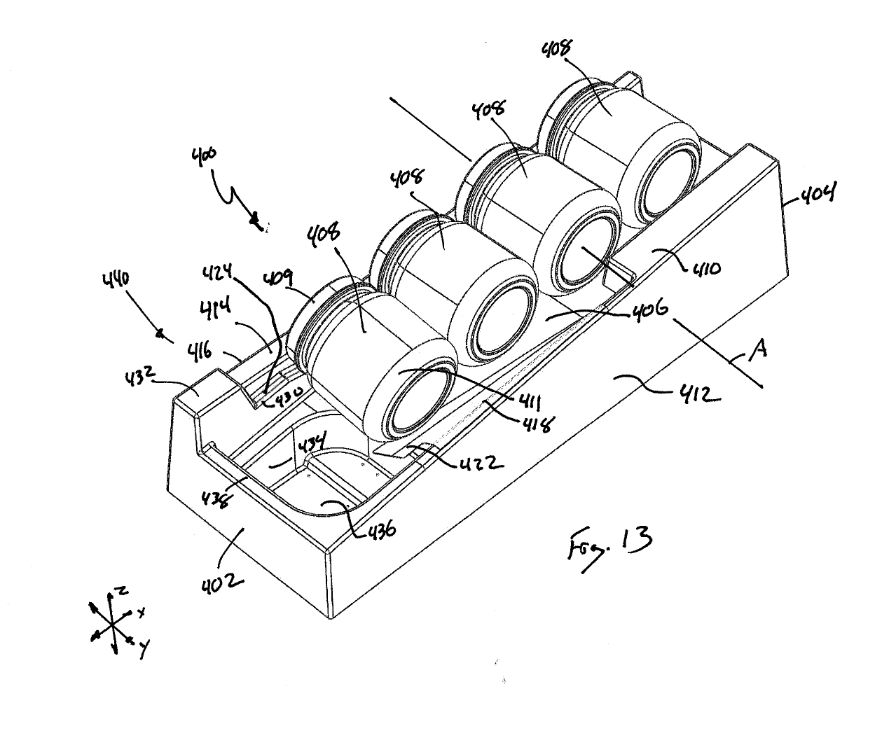

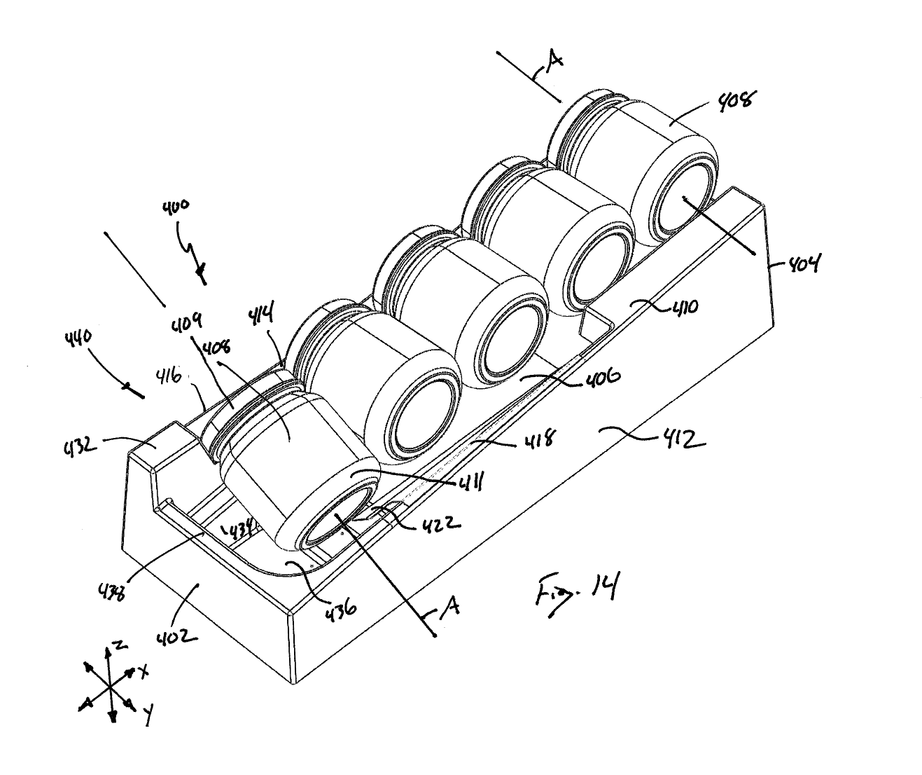

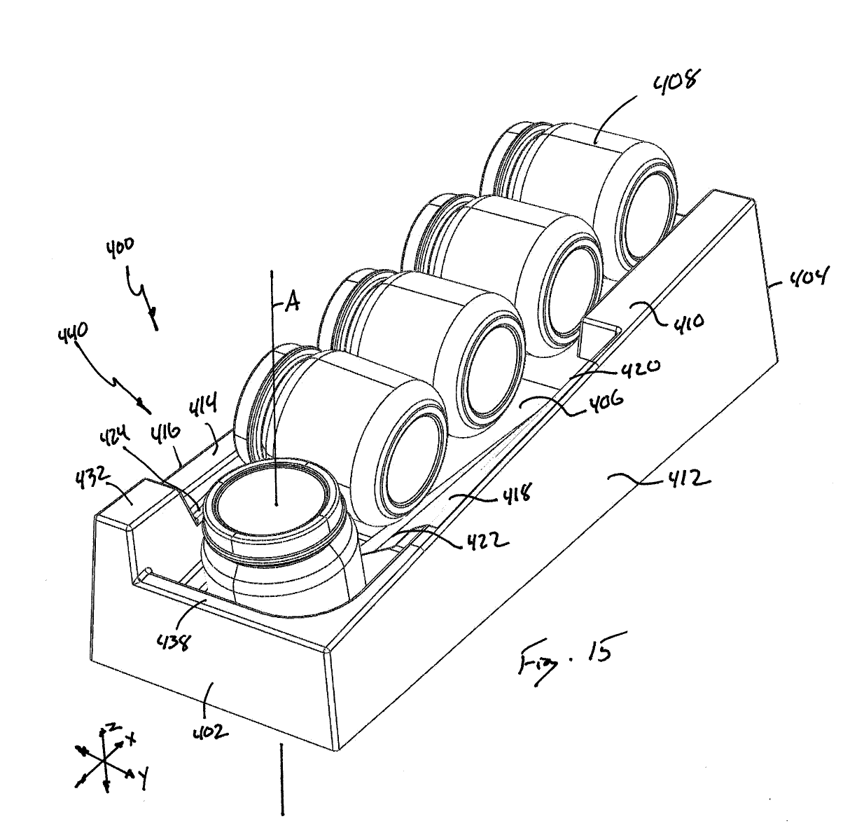

Thus, products 408 positioned in a rolling configuration (i.e., with the rolling axis A aligned with the y-axis) proximate the rear end 404 of the support structure 400 may be urged to roll toward the front end 402 of the support structure 400 under the force of gravity. As each product 408 approaches the rear ends 420, 428 of the ramps 418, 424, the first end 409 of the product 408 may ride up the second ramp 424 and the second end 411 of the product 408 may ride up the first ramp 418, as shown in FIG. 13. As the first end 409 of the product 408 engages the catch member 432, the catch member 432 may inhibit or interfere with further distal movement of the first end 409 while the second end 411 of the product 408 continues to move in the distal direction, resulting in rotation of the product 408 in the x-y plane, as shown in FIG. 14. As the second end 411 of the product 408 continues to move in the distal direction, the second end 411 eventually drops off of the front end 422 of the first ramp 420 and into the recess 434, as shown in FIG. 15, thereby reorienting the product 408 in a vertical configuration (i.e., the rolling axis A is parallel with the z-axis).

Accordingly, the support structure 400 may direct products from the rear end 404 to the product display area 440 at the front end 402 under the force of gravity. Simultaneously, the support structure 400 may reorient the rolling axis A of each product 408 into a vertical configuration (i.e., aligned with the z-axis) as the product 408 moves to the product display area 440.

Although various aspects of the disclosed product dispensing and orienting system have been shown and described, modifications may occur to those skilled in the art upon reading the specification. The present application includes such modifications and is limited only by the scope of the claims.

What is claimed is:

1. A product dispensing system comprising:
a support structure;
a product in rolling engagement with said support structure, said product having a first end and a second end, said second end being spaced from said first end along a rolling axis; and
a catch member positioned to engage said first end of said product and reorient said rolling axis as said product moves along said support structure.

2. The product dispensing system of claim 1 with the proviso that said catch member engages said first end of said product without engaging said second end of said product.

3. The product dispensing system of claim 1 wherein said catch member is integral with said support structure.

4. The product dispensing system of claim 1 wherein said support structure includes a front end spaced from a rear end along a longitudinal axis of said support structure.

5. The product dispensing system of claim 4 wherein said support structure defines a rolling surface extending from said front end of said support structure to said rear end of said support structure.

6. The product dispensing system of claim 5 wherein said rolling surface is inclined.

7. The product dispensing system 6 wherein said rolling surface extends between laterally opposed first and second side walls.

8. The product dispensing system of claim 7 wherein said catch member is connected to said first side wall.

9. The product dispensing system of claim 6 wherein said support structure defines a ramp extending along said first side wall, said ramp having a front end and a rear end, said catch member being positioned proximate said front end of said ramp.

10. The product dispensing system of claim 9 wherein said support structure further defines a second ramp extending along said second side wall, said second ramp having a front end and a rear end, said front end of said second ramp being spaced from said front end of said support structure.

11. The product dispensing system of claim 5 wherein said support structure defines an elongated cradling recess in said rolling surface.

12. The product dispensing system of claim 5 wherein said support structure defines a vertical recess in said rolling surface, said vertical recess being positioned proximate said front end of said support structure.

13. The product dispensing system of claim 1 further comprising a holder connected to said support structure to receive said product from said support structure, wherein said catch member is defined by said holder.

14. A product dispensing system comprising:
a frame having an upper support structure and a lower support structure;
a container housing a plurality of products, each product of said plurality of products having a first end and a second end, said second end being spaced from said first end along a rolling axis, wherein said container is supported on said upper support structure such that said frame directs said plurality of products to said lower support structure; and
a catch member positioned to engage said first ends of said plurality of products and reorient said rolling axes of said plurality of products as said plurality of products move along said lower support structure.

15. The product dispensing system of claim 14 wherein said lower support structure includes a front end and a rear end and is inclined from said front end to said rear end such that said plurality of products move along said lower support structure to said front end under the force of gravity.

16. The product dispensing system of claim 15 further comprising a holder connected to said front end of said lower support structure, wherein said holder defines said catch member and recess for individually receiving said plurality of products.

17. A method for dispensing a product, said product having a first end and a second end, said second end being spaced from said first end along a rolling axis, said method comprising the steps of:
providing a support structure that defines a rolling surface;
positioning said product on said rolling surface such that said product rolls about said rolling axis along said rolling surface; and
as said product is rolling along said rolling surface, catching one of said first and second ends to cause said rolling axis to rotate.

18. The method of claim 17 wherein said rolling axis rotates from a first horizontal configuration to a second horizontal configuration.

19. The method of claim 17 wherein said rolling axis rotates from a horizontal configuration to a vertical configuration.

20. The method of claim 17 further comprising the step of receiving said product in a recess after said catching step.
